(19) United States
(12) Patent Application Publication
(10) Pub. No.: US 2022/0061626 A1
(43) Pub. Date: Mar. 3, 2022

(54) WAREWASH MACHINE DRAIN DOWN PROCESS AND ASSOCIATED WAREWASH MACHINE

(71) Applicant: ILLINOIS TOOL WORKS INC., Glenview, IL (US)

(72) Inventors: Andrew J. CARPENTER, Beavercreek, OH (US); Jeffrey R. NEWCOMER, Troy, OH (US); Alexander R. ANIM-MENSAH, Dayton, OH (US)

(21) Appl. No.: 17/010,276

(22) Filed: Sep. 2, 2020

(51) Int. Cl. A47L 15/42; A47L 15/00

(52) U.S. Cl. CPC A47L 15/4225; A47L 15/0047; A47L 15/4285; A47L 2501/30; A47L 2501/02; A47L 2501/01; A47L 2401/06

(57) ABSTRACT

A method of draining a wash tank of a warewash machine involves: (a) turning off, or maintaining off, both a booster tank heater and a wash tank heater of the machine; (b) simultaneously operating a rinse pump, operating a drain pump and opening a booster fill valve of the machine so that all of the following take place at the same time: (b1) fresh water is delivered through a heat exchanger to the booster tank; (b2) fresh water is delivered by the rinse pump from the booster tank to a rinse spray system and falls down into the wash tank; and (b3) liquid from the wash tank is delivered by the drain pump to a drain flow path and through the heat exchanger to exchange heat with the fresh water delivered through the heat exchanger.

### TECHNICAL FIELD

This application relates generally to warewash machines for washing wares and, more specifically, to a warewash machine drain down process of such a warewash machine.

### BACKGROUND

In some jurisdictions, the plumbing code requires that all hot water to the drains needs to be at most 140° F. In hot operated warewash machines the exiting drain water (e.g., from the wash tank) is commonly over 140 F. This necessitates tempering before discharge through the plumbing network.

For some machines, to temper drain water, a large volume of colder fresh water is directly mixed with the machine exiting hot drain water, such as in a drain box or compartment along the drain line, to bring the temperature to below 140° F. before discharge. These tempering systems are known as direct drain water tempering (DWT). While this DWT process assists in getting the drain to meet the temperature requirements, it is associated with substantial freshwater use, and is not water efficient and economical.

The goal of reducing the amount of freshwater usage caused by DWT systems lead to the development of an alternative, in the form of drain water energy recovery (DWER) systems. DWER systems allow for recovery of heat from the hot waste machine drain water using heat exchangers, while in the process the hot drain water cools to below the 140° F. limit. In most cases, the recovered heat is reused for preheating incoming fresh cold water to the machine especially the rinse water.

The DWER technology is an improvement over the DWT system, requiring significantly less amount of fresh cold water for tempering, which mainly occurs during machine shutdown. Moreover, the tempering water used during the shutdown has the benefit of being used for machine wash tank and DWER system self-cleaning, resulting energy and water savings.

However, improvements that reduce water usage and/or facilitate faster draining of the machine wash tank are still desired.

### SUMMARY

In one aspect, a method of draining a wash tank of a warewash machine involves: (a) turning off, or maintaining off, both a booster tank heater and a wash tank heater of the machine; (b) simultaneously operating a rinse pump, operating a drain pump and opening a booster fill valve of the machine so that all of the following take place at the same time: (b1) fresh water is delivered through a heat exchanger to the booster tank; (b2) fresh water is delivered by the rinse pump from the booster tank to a rinse spray system and falls down into the wash tank; and (b3) liquid from the wash tank is delivered by the drain pump to a drain flow path and through the heat exchanger to exchange heat with the fresh water delivered through the heat exchanger.

In another aspect, a method is provided for draining a wash tank of a warewash machine that includes a ware spray zone, a wash pump, a wash spray system, a booster tank, a rinse pump, a rinse spray system, a drain pump, a drain flow path, a fresh water input path, a booster fill valve and a heat exchanger. The wash tank is located below the ware spray zone and includes a wash tank heater. The wash pump includes an input connected to receive liquid from the wash tank and an output connected to deliver liquid to the wash spray system. The heat exchanger is located along the fresh water input path and along the drain flow path for heat exchange between liquid traveling along the drain flow path and fresh water traveling along the fresh water input path. The booster tank includes heater, an input connected to receive fresh water from the heat exchanger as controlled by the booster fill valve, and an output connected to deliver fresh water to an input of the rinse pump. The rinse pump includes an output connected to deliver fresh water to the rinse spray system. The drain pump includes an input connected to receive liquid from the wash tank and an output connected to the drain flow path. The method involves, responsive to a wash tank drain down trigger, carrying out a drain down process in which: (a) if the wash tank heater is on, turning off the wash tank heater for the drain down process or, if the wash tank heater is off, maintaining the wash tank heater off for the drain down process; (b) if the booster tank heater is on, turning off the booster tank heater for the drain down process or, if the booster tank heater is off, maintaining the booster tank heater off for the drain down process; and (c) simultaneously operating the rinse pump, operating the drain pump and opening the booster fill valve so that all of the following take place at the same time: (c1) fresh water is delivered through the heat exchanger to the booster tank, (c2) fresh water is delivered by the rinse pump from the booster tank to the rinse spray system and falls down into the wash tank, and (c3) liquid from the wash tank is delivered by the drain pump to the drain flow path and through the heat exchanger to exchange heat with the fresh water delivered through the heat exchanger.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic depiction of one embodiment of a warewash machine;

FIG. 2 is a time graph of one wash tank drain down operation; and

FIG. 3 is a time graph of another wash tank drain down operation.

### DETAILED DESCRIPTION

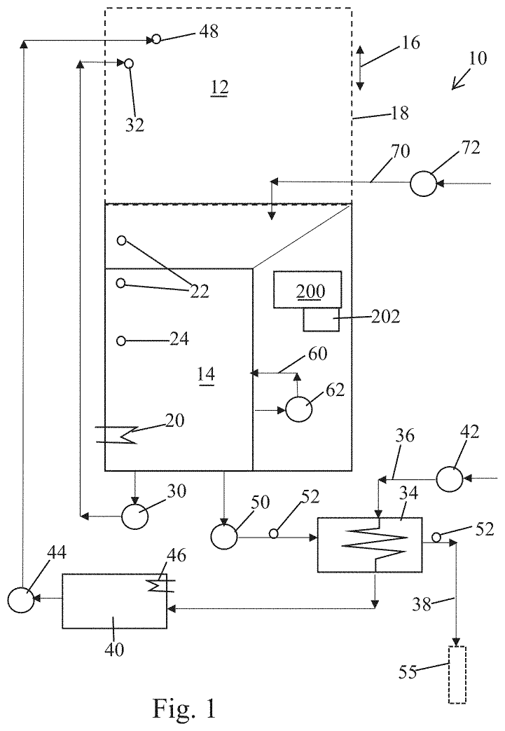

Referring to FIG. 1, a warewash machine 10 is shown and includes a ware spray zone 12 above a wash tank 14, where the spray zone may be accessible by a door, such as a hood-type door 18 that can be raised, by pivoting or sliding, per arrow 16, for access to the spray zone 12 (e.g., to move racks of wares in and out of the spray zone). The wash tank 14 is located below the ware spray zone and includes a wash tank heater 20 for heating wash liquid within the tank to an operating temperature (e.g., between 150° F. and 165° F.). The wash tank may also include one or more level sensors 22 and a temperature sensor 24.

A wash pump 30 includes an input connected to receive liquid from the wash tank 14 and an output connected to deliver liquid to a wash spray system 32 (e.g., one or more spray nozzles that spray the wash liquid onto wares for cleaning the wares). A heat exchanger 34 is located along a fresh water input path 36 and along a drain flow path 38 for heat exchange between liquid traveling along the drain flow path and fresh water traveling along the fresh water input path. A booster tank 40 includes an input connected to receive fresh water from the heat exchanger 34 as controlled by a booster fill valve 42, an output connected to deliver fresh water to an input of a rinse pump 44, and also includes a booster tank heater 46 for heating the fresh water in the tank to a desired rinse temperature (e.g., between 180° F. and 192° F.). The rinse pump 44 includes an output connected to deliver fresh water to a rinse spray system 48 (e.g., one or more spray nozzles that spray the fresh water (e.g., potable water or potable water with rinse agent) as rinse liquid onto wares for rinsing). A drain pump 50 includes an input connected to receive liquid from the wash tank 14 and an output connected to the drain flow path 38 to deliver liquid from the wash tank to the heat exchanger 34. Temperature sensors 52 may also be provided for detecting the temperature of draining wash tank liquid both before and after passing through the heat exchanger 34. The drain flow path 38 connects to a site drain 55.

A controller 200 controls the various machine components for cleaning cycles (e.g., wash phase followed by a rinse phase) and other purposes, including machine-startup, machine cleaning and machine shutdown. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof.

Complete or substantially complete draining of the wash tank 14 may typically occur during either a machine cleaning operation (as initiated by an operator pushing a machine clean input button associated with a user interface 202 during the day) or a machine shutdown operation (as initiated by an operator turning off the machine via the interface 202 at the end of the day).

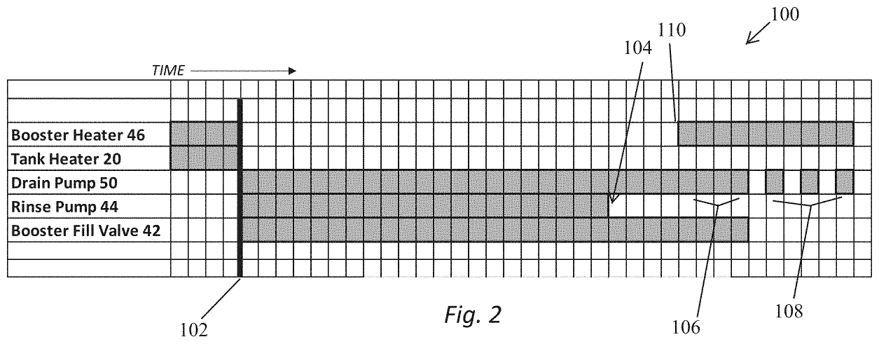

Referring to FIG. 2, an exemplary wash tank draining process as part of a machine cleaning operation, under control of the controller 200, is shown in a time graph 100 where time is on the horizontal, and each block represents a set amount of time (e.g., 3-5 seconds). A solid block for any of the booster heater row, sump heater row, drain pump row, rinse pump row represents that the component is on/operating, and a blank block for any of the booster heater row, sump heater row, drain pump row, rinse pump row represents that the component is not on/not operating. A solid block for the booster fill valve row represents that the valve is open and a blank block for the booster fill valve row represents that the valve is closed.

Line 102 represents the point in time when the drain down process is triggered. As shown, the booster heater 46 and wash tank heater 20 are both immediately turned off (or maintained off if not on), and then the drain pump 50 and rinse pump 44 are both turned on to operate simultaneously, while at the same time the booster fill valve 42 is opened. As a result, fresh water is delivered through the heat exchanger 34 to the booster tank 40, and fresh water is delivered by the rinse pump 44 from the booster tank 40 to the rinse spray system 44 and falls down into the wash tank 14, and liquid from the wash tank 14 is delivered by the drain pump 50 to the drain flow path 38 and through the heat exchanger 34 to exchange heat with the fresh water delivered through the heat exchanger, all at the same time. In the exemplary embodiment, the drain pump 50 and rinse pump 44 are both turned on at the same time as the booster fill valve 42 in order to achieve the simultaneous operation described above. However, it is recognized that a slight staggering between pump start times and valve opening could also be implemented to achieve the simultaneous pump operation that overlaps with the fill valve open condition (e.g., open booster fill valve 42 first, then turn on rinse pump 44 and then turn on drain pump 50).

Even though the fresh water delivered from the booster tank 40 to the wash spray system 32 may initially be above the temperature of the liquid in the wash tank (e.g., for the first 20-30 seconds following initiation of the drain down), heat exchange of the draining tank liquid with the incoming fresh water assures that the temperature of water reaching the site drain 55 is below the set code limit (e.g., typically 140° F.). The incoming fresh water to the booster tank eventually (e.g., after the 20-30 seconds) lowers the temperature of the water in the booster sufficiently so that the fresh water delivered via the wash spray system 32 also brings down the temperature of the liquid in the wash tank during the draining.

After a set time period, or once the temperature of the liquid in the wash tank is detected to be below the set code limit, the rinse pump is turned off, as indicated at 104. Here, the booster fill valve is maintained in the open state because the booster tank needs to be filled so that the machine is ready for operation following completion of the draining. The drain pump 50 also continues to operate until to assure substantially complete draining of the wash tank 14. For example, the drain pump may operate until water is below a sensor, then for an additional time period 106 and then with a sequence of pulse operations 108. The booster heater is also turned on again, as at 110, to begin to get the water up to needed temperatures. The booster water can then be used to refill the machine to get the machine ready for subsequent cleaning cycles.

An exemplary wash tank draining process as part of a machine shutdown operation is shown in a time graph 120 (similar to graph 100) where time is on the horizontal. This process is very much the same as that of graph 100, except that, when the rinse pump 44 is turned off at 104, the booster fill valve 42 is also closed, because refilling of the booster tank is not needed. In addition, the booster heater is not turned back on.

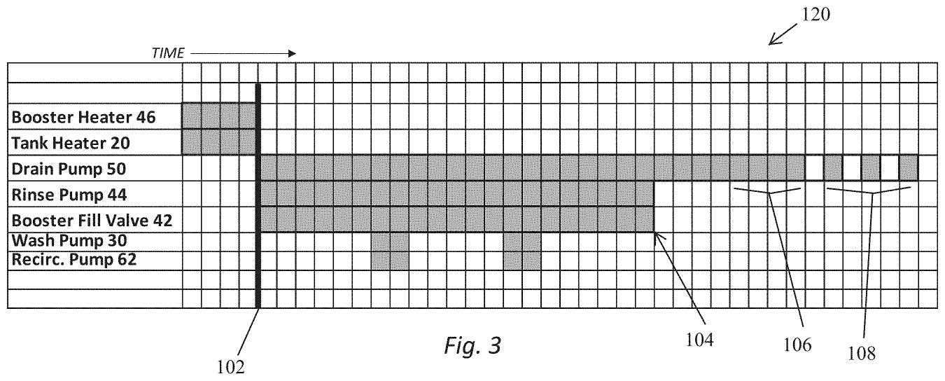

Variations in the drain down process are possible. For example, as optionally suggested in FIG. 3, the wash pump 30 could be occasionally operated during the simultaneous operation of the drain pump and rinse pump, to assist in mixing the liquid in the tank for more uniform temperature. This occasional wash pump operation could be based upon monitoring of the wash tank liquid temperature (via sensor 24) and/or based upon monitored wash tank liquid level (via sensors 22). Alternatively, or in addition, per FIG. 1, the wash tank could include a recirculation line 60 and recirculation pump 62 that is occasional operated (per FIG. 3) to mix the wash tank liquid without directing the liquid through the wash spray system 32. These same additions could be incorporated into the drain down process of FIG. 2.

Moreover, optionally, per FIG. 1, the warewash machine 10 could also include a separate wash tank fill line 70 under control of a fill valve 72. In such machines, the wash tank fill valve 72 could be controlled to open during the initial drain down so to directly temper the water in the wash tank (e.g., at least in part simultaneous with operation of the rinse pump 44, operation of the drain pump 50 and the open state of the booster tank fill valve 42), and the wash pump 30 and/or recirculation pump 62 (if present) could occasionally be operated to mix the liquid in the tank. The tank fill valve could be controlled to close if an upper limit level of liquid in the wash tank is reached.

It is to be clearly understood that the above description is intended by way of illustration and example only, is not intended to be taken by way of limitation, and that other changes and modifications are possible. For example, for any wash tank drain down process, the controller 200 may first check the temperature of liquid in the wash tank and, if such temperature is already below the applicable code limit, the drain down could be implemented solely by operation of the drain pump 50, because reduction of the temperature of the draining wash tank liquid is not needed. Still other modifications and variations are possible.

What is claimed is:

1. A method of draining a wash tank of a warewash machine, the method comprising:
(a) turning off, or maintaining off, both a booster tank heater of a booster tank and a wash tank heater of awash tank the machine;
(b) simultaneously operating a rinse pump, operating a drain pump and opening a booster fill valve of the machine so that all of the following take place at the same time:
(b1) fresh water is delivered through a heat exchanger to the booster tank;
(b2) fresh water is delivered by the rinse pump from the booster tank to a rinse spray system and falls down into the wash tank; and
(b3) liquid from the wash tank is delivered by the drain pump to a drain flow path and through the heat exchanger to exchange heat with the fresh water delivered through the heat exchanger.

2. The method of claim 1, wherein steps (a) and (b) are initiated in response to triggering of one of a machine shut down operation or a machine cleaning operation.

3. The method of claim 1, wherein at least one of:
operation of the rinse pump per step (b) is stopped when a detected temperature of liquid in the wash tank is below a threshold temperature;
or
operation of the rinse pump per step (b) is stopped after a set time period.

4. The method of claim 3, wherein the wash tank drain down is initiated in response to a machine shutdown operation and:
the booster fill valve is closed simultaneous with ceasing operation of the rinse pump; and
the drain pump continues to operate for at least some time period after closure of the booster fill valve and ceasing operation of the rinse pump.

5. The method of claim 3, wherein the wash tank drain down is initiated in response to a machine cleaning operation and:
the booster fill valve remains open after ceasing operation of the rinse pump and until a set fill level for the booster tank is reached;
the drain pump continues to operate for at least some time period after ceasing operation of the rinse pump.

6. The method of claim 1, wherein the rinse pump and the drain pump are turned on at a same time, and the booster fill valve is opened at the same time, in order to initiate step (b).

7. The method of claim 1, wherein, during step (b):
(b4) a wash pump is operated on one or more occasions, but is not operated continuously;
and/or
(b5) a recirculation pump associated with the wash tank is operated on one or more occasions, but is not operated continuously.

8. The method of claim 1, including detecting that a temperature of liquid in the wash tank is above a set threshold before carrying out step (b).

9. The method of claim 1, wherein the warewash machine includes a second fill line that delivers fresh water to the wash tank without passing the fresh water through the booster tank, the second fill line having an associated tank fill valve, and wherein step (b) further includes opening the tank fill valve simultaneous with operating the rinse pump, operating the drain pump and opening the booster fill valve.

10. A method of draining a wash tank of a warewash machine that includes a ware spray zone, a wash tank, a wash pump, a wash spray system, a booster tank, a rinse pump, a rinse spray system, a drain pump, a drain flow path, a fresh water input path, a booster fill valve and a heat exchanger;
wherein the wash tank is located below the ware spray zone and includes a wash tank heater;
wherein the wash pump includes an input connected to receive liquid from the wash tank and an output connected to deliver liquid to the wash spray system;
wherein the heat exchanger is located along the fresh water input path and along the drain flow path for heat exchange between liquid traveling along the drain flow path and fresh water traveling along the fresh water input path;
wherein the booster tank includes an input connected to receive fresh water from the heat exchanger as controlled by the booster fill valve, an output connected to deliver fresh water to an input of the rinse pump, and a booster tank heater;
wherein the rinse pump includes an output connected to deliver fresh water to the rinse spray system;
wherein the drain pump includes an input connected to receive liquid from the wash tank and an output connected to the drain flow path;
wherein the method comprises:
responsive to a wash tank drain down trigger, carrying out a drain down process in which:
(a) if the wash tank heater is on, turning off the wash tank heater for the drain down process or, if the wash tank heater is off, maintaining the wash tank heater off for the drain down process;
(b) if the booster tank heater is on, turning off the booster tank heater for the drain down process or, if the booster tank heater is off, maintaining the booster tank heater off for the drain down process; and
(c) simultaneously operating the rinse pump, operating the drain pump and opening the booster fill valve so that all of the following take place at the same time:
(c1) fresh water is delivered through the heat exchanger to the booster tank,
(c2) fresh water is delivered by the rinse pump from the booster tank to the rinse spray system and falls down into the wash tank, and
(c3) liquid from the wash tank is delivered by the drain pump to the drain flow path and through the heat exchanger to exchange heat with the fresh water delivered through the heat exchanger.

11. The method of claim 10, wherein the wash tank drain down trigger is effected by one of a machine shut down operation or a machine cleaning operation.

12. The method of claim 10, wherein at least one of:
operation of the rinse pump per step (c) is stopped when a detected temperature of liquid in the wash tank is at or below a threshold temperature;
or
operation of the rinse pump per step (c) is stopped after a set time period.

13. The method of claim 12, wherein the wash tank drain down trigger is effected by a machine shutdown operation and:
the booster fill valve is closed simultaneous with ceasing operation of the rinse pump; and
the drain pump continues to operate for at least some time period after closure of the booster fill valve and ceasing operation of the rinse pump.

14. The method of claim 12, wherein the wash tank drain down trigger is effected by a machine cleaning operation and:
the booster fill valve remains open after ceasing operation of the rinse pump and until a set fill level for the booster tank is reached; and
the drain pump continues to operate for at least some time period after ceasing operation of the rinse pump.

15. The method of claim 10, wherein the rinse pump and the drain pump are turned on at a same time, and the booster fill valve is opened at the same time, in order to initiate step (c).

16. The method of claim 10, wherein, during step (c):
(c4) the wash pump is operated on one or more occasions, but is not operated continuously;
and/or
(c5) a recirculation pump associated with the wash tank is operated on one or more occasions, but is not operated continuously.

17. The method of claim 10, including detecting that a temperature of liquid in the wash tank is above a set threshold before carrying out step (c).

18. The method of claim 10, wherein the warewash machine includes a second fill line that delivers fresh water to the wash tank without passing the fresh water through the booster tank, the second fill line having an associated tank fill valve, and wherein step (c) further includes opening the tank fill valve simultaneous with operating the rinse pump, operating the drain pump and opening the booster fill valve.

19. A warewash machine, comprising:
a spray zone with a wash spray system and a rinse spray system;
a wash tank below the spray zone and including a wash tank heater;
wherein the wash spray system is fed by a wash pump connected to the wash tank;
wherein the rinse spray system is fed by a rinse spray pump connected to a booster tank, wherein the booster tank includes a booster heater, and wherein the booster tank is fed via a booster fill path under control of a booster fill valve;
a drain pump connected to the wash tank for delivering wash tank liquid to a drain flow path;
a heat exchanger connected in both the booster fill path and the drain flow path for heat exchange between water traveling along the booster fill path and wash tank liquid traveling along the drain flow path;
a controller configured to carry out a wash tank drain down process that involves simultaneously (i) operating the rinse pump, (ii) operating the drain pump and (ii) opening the booster fill valve so that all of the following take place at the same time:
(1) fresh water is delivered through the heat exchanger to the booster tank;
(2) fresh water is delivered by the rinse pump from the booster tank to the rinse spray system and falls down into the wash tank; and
(3) liquid from the wash tank is delivered by the drain pump to the drain flow path and through the heat exchanger to exchange heat with the fresh water delivered through the heat exchanger.

20. The warewash machine of claim 19, wherein the controller is configured to turn off both the wash tank heater and the booster heater during simultaneously (i) operating the rinse pump, (ii) operating the drain pump and (iii) opening the booster fill valve.
